(19) United States
(12) Patent Application Publication
(10) Pub. No.: US 2013/0232526 A1
(43) Pub. Date: Sep. 5, 2013

(54) APPLICATION CLIENT FOR A GATEWAY SYSTEM

(71) Applicants: Chad Andrew Lefevre, Indianapolis, IN (US); Martin Vincent Davey, Indianapolis, IN (US)

(72) Inventors: Chad Andrew Lefevre, Indianapolis, IN (US); Martin Vincent Davey, Indianapolis, IN (US)

(73) Assignee: THOMSON LICENSING, Issy de Moulineaux (FR)

(21) Appl. No.: 13/883,632

(22) PCT Filed: Nov. 9, 2010
(86) PCT No.: PCT/US10/02949

§ 371 Date: May 6, 2013

(51) Int. Cl. H04N 21/258

(52) U.S. Cl. CPC H04N 21/25866
USPC 725/37

(57) ABSTRACT

Methods and systems for employing a set top box as a gateway application client are disclosed. The set top box can permit a user to interact with a gateway directly and efficiently to run applications or modify configuration settings of the gateway. Further, the set top box can be configured to include an executable file or application to perform at least a portion of processing of one or more applications provided at the gateway. In addition, the set top box can perform a display/input function and act as a conduit for information transmitted between a user and a gateway.

### BACKGROUND

Residential gateways provide home users with a means to connect computing devices to the internet or other wide area networks. Many currently available home gateways provide auto-configuration features in addition to an array of other types of applications. Home gateways have a few ways to permit its user to modify its settings and to use its applications. For example, certain gateways provide users with a remote handset to modify settings and run gateway applications. Alternatively, gateway settings can be modified through a web browser, which can be redundant, as some gateway applications can mimic functions that can be performed through a browser.

### SUMMARY

While currently available residential gateways provide some different means for modifying their configuration settings and running gateway applications, the use of such features is inconvenient in many respects. For example, adjusting configuration settings and executing other gateway applications through a web browser is time consuming and circuitous due to the use of the Internet to access applications present on a user's home network. Further, handsets are an expensive addition to a gateway system and provide a small screen with which navigation is relatively difficult to perform.

Known gateway systems fail to exploit the potential of employing existing devices that are available through a common service provider and are already present on a user's home network. In particular, many gateway systems utilized by users are supplied by cable service providers, which in turn also provide set top boxes to permit users to subscribe to premium television channels, among other services. Moreover, set top boxes can provide a direct connection to a gateway system and can conveniently provide a user with a large screen to interact with the gateway system. Furthermore, because the set top box system and gateway system can be supplied by a common service provider, the systems can interact in accordance with a communication protocol defined by the service provider to enable efficient transmission of information between the two systems. In addition, the service provider can configure the systems such that an executable file or application can be stored at the set top box to perform at least a portion of the processing of one or more applications provided at the gateway to improve communication efficiency and to reduce processing latency.

In accordance with one exemplary embodiment described herein, a method can be performed by a set top box to permit a user to interact with a gateway system. Here, a set top box can receive information identifying a user-selection of an application provided at the gateway system. In addition, a request to initialize the selected application can be transmitted from the set top box to the gateway system. Further, the set top box can direct the display of output data resulting from execution of a process by the selected application.

Another exemplary embodiment is also directed to a method. In the method, a gateway system can receive, from a set top box, a request for the execution of a process by an application provided at the gateway system or for application data resulting from execution of the process by the application. Thereafter, the gateway can execute the process to generate the application data and can transmit the application data to the set top box.

An alternative exemplary embodiment is directed to a system. The system can include a gateway system that is configured to provide at least one application. The system can further include a set top box that is configured to direct the presentation of a list of applications available at the gateway system to a user. Here, the set top box can enable a user to interact with the gateway system through the set top box to permit execution of a selected application.

### BRIEF DESCRIPTION OF THE DRAWINGS

The embodiments can be readily understood by considering the following detailed description in conjunction with the accompanying drawings, in which:

FIG. 1 is a block diagram of an implementation of a system for employing a set top box as an application client for a gateway.

FIG. 2 is a block/flow diagram of an implementation of a gateway system.

FIG. 3 is a block/flow diagram of an implementation of a set top box system.

FIG. 4 is a block/flow diagram of an implementation of a method for setting up a set top box as an application client for a gateway.

FIG. 5 is a block/flow diagram of an implementation of a method for employing a set top box as an application client for a gateway.

FIG. 6 is block/flow diagram of an implementation of a method for running a gateway application with a set top box.

FIG. 7 is block/flow diagram of an implementation of a method for running a gateway application at a gateway.

FIG. 8 is a block/flow diagram of an implementation of a method for transmitting an updated gateway application list to a set top box.

FIG. 9 is a block/flow diagram of an implementation of a method for updating a gateway application list at a set top box.

FIG. 10 is a diagram of several screen shots that can be displayed during implementation of various method embodiments.

It should be understood that the drawings are for purposes of illustrating the concepts and are not necessarily the only possible configurations. To facilitate understanding, identical reference numerals have been used, where possible, to designate identical elements that are common to the figures.

### DETAILED DESCRIPTION

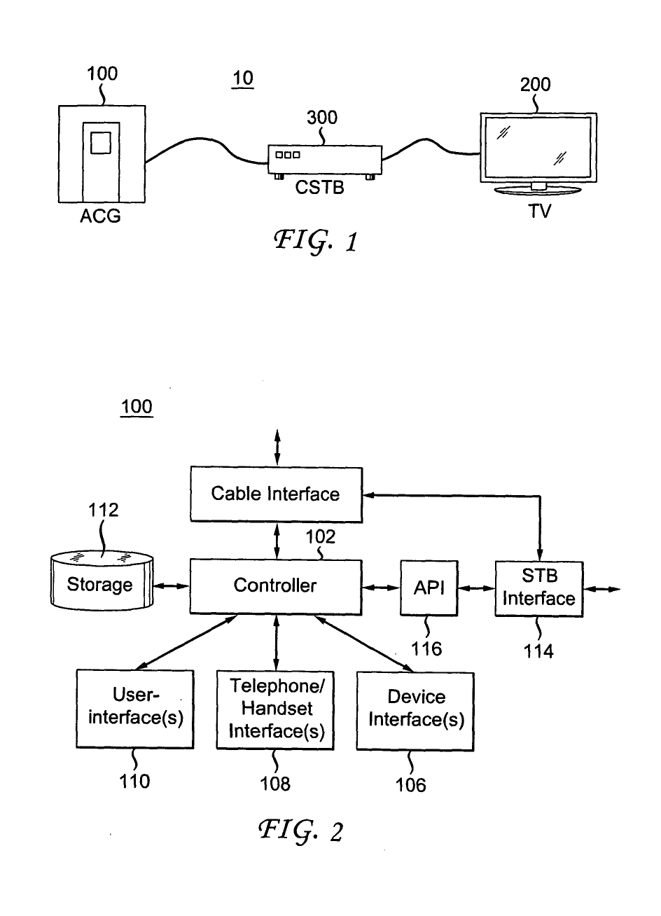

Referring now in specific detail to the drawings in which like reference numerals identify similar or identical elements throughout the several views, and initially to FIG. 1, an exemplary system 10 in which method embodiments can be implemented is illustrated. The system 10 can include a gateway system 100, a set top box (STB) system 300 and a display system 200. The gateway system 100 and the set top box system 300 can be issued by a cable service provider to render broadband services and television services, respectively, to a user. For example, the gateway system 100 can be an advanced cable gateway (ACG) while the set top box system 300 can be a cable set top box (CSTB). Further, the display system 200 can be a television system and the like.

With reference now to FIG. 2, with continuing reference to FIG. 1, an exemplary gateway system 100 is illustrated. The system 100 can include a controller 102, a set top box interface 104, a device interface(s) 106, a telephone/handset interface(s) 108, a user-interface 110, a storage medium 112, a cable interface 114 and an application program interface 116. The controller 102 can be implemented by one or more processors and can be configured to control operation of the other elements in the gateway system 100. In particular, the controller 102 can be configured to implement method embodiments described further herein below using other elements of the gateway system 100. Moreover, the controller 102 can execute applications stored in the storage medium 112 independently in accordance with user-instructions received through, for example, the user-interfaces 110. Alternatively, the controller 102 can execute applications stored in the storage medium 112 with user-instructions received through the set top box 300, as described in more detail herein below. The set top box interface 104 can be employed to connect the gateway system 100 to the set top box system 300. For example, the interface 104 can be utilized to implement application proxy methods discussed herein below. In addition, an application program interface (API) 116 can be configured to interact between the systems 100 and 300 to enable communication between the systems for implementation of such methods. It should be noted that although the API 116 is provided here in the gateway system 100, the API 116 can alternatively be included in the set top box system 300, described in more detail below. It should also be noted that the interface 104 can be utilized to perform other functions with regard to the set top box. For example, the gateway system 100 can act as a conduit to transmit information to and receive information from the STB system 300 to permit the provision of television services and the like. For example, a cable head end (not shown) can transmit broadcast television video and audio data, on-demand video and audio data, program schedule information, etc., through the gateway system 100 to the set top box 300 for presentation on the display system 200. In turn, the gateway system 100 can employ the interface 104 to receive information from the STB 300 for transmission to the cable head end. The interface 104 can be a wired or wireless interface. For example, the interface 104 can be a Multimedia over Coax Alliance (MoCA) interface or can be a wireless interface in conformance with Institute of Electrical and Electronics Engineers (IEEE) 802.11 standards, etc.

The cable interface 114 can be configured to connect the gateway system 100 to the cable head end via a service provider-wide area network. The wide area network can have wired and/or wireless portions and can provide a connection to other wide area networks, such as the internet. The storage medium 112 can be configured to store application programs, described in more detail herein below, and to store instructions to implement method embodiments. The user-interface 110 can be a display screen provided on the gateway system along with a keypad to permit the input of information by user. Additionally or alternatively, the user-interface 110 can be a touch-screen. Additionally or alternatively, the user-interface 110 can be a wired or wireless interface for a remote handset (not shown) that includes its own screen, touch-screen and/or keypad. The user-interface 110 can be employed to initiate and execute the application programs stored in the storage medium 112. The telephone/handset interface 108 can provide a connection to one or more telephones/handsets. For example, the interface 108 can be employed to implement Voice over Internet Protocol (VoIP) Services. Further, the telephone handsets can be configured to also perform the same functions described above with respect to the user-interface 110. The device interface(s) 106 can enable the connection of computing devices, such as a personal computer, a laptop or a smart phone, and/or the connection of network devices, such as a router for a local area network, to the gateway system 100. Here, the device interface(s), for example, can be employed to provide broadband services for connection to a wide area network, such as the internet. Further, the device interface(s) 106 can be wired and/or wireless.

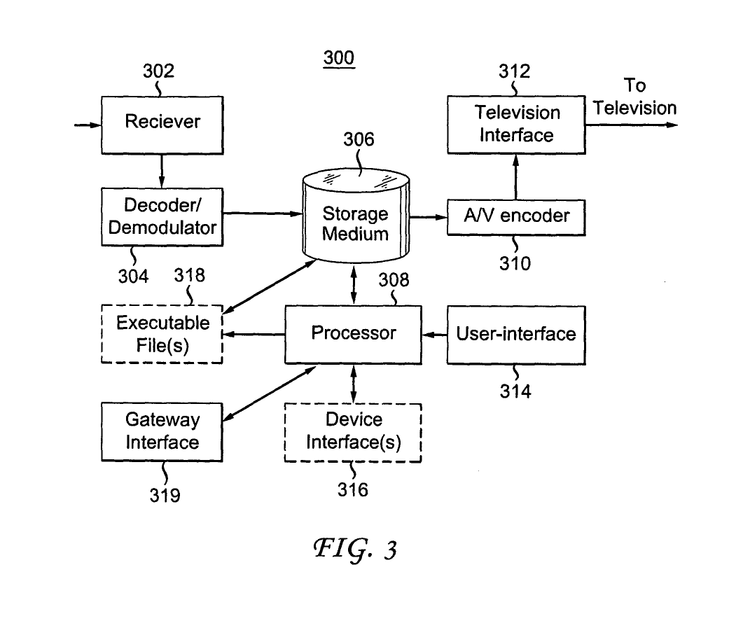

With reference now to FIG. 3, with continuing reference to FIG. 1, an exemplary set top box system 300 is illustrated. The set top box system 300 can include a receiver 302, a decoder/demodulator 304, optional executable files or applications 318, a storage medium 306, a processor 308, a gateway interface 309 an audio/video encoder 310, a television interface 312, a user-interface 314 and one or more optional device interfaces 316. Here, the receiver 302 can be configured to receive signals from the cable head end (not shown). For example, the receiver 302 can be a cable interface that can be configured to connect to a wide area network of a service provider for the receipt of broadcast television video and audio data, on-demand video and audio data, program schedule information, etc., from the cable head end. Alternatively, the STB system 300 can communicate with the head end through the gateway interface 309, as discussed above. For example, the gateway interface 309 can be configured to connect the STB system 300 to the STB interface 104 of the gateway system 100. In addition, the gateway interface 309 can be employed by the processor 308 to implement method embodiments described herein. Further, the gateway interface 309 can be wired or wireless. For example, the gateway interface 309 can be a MoCA interface or can be a wireless interface in conformance with IEEE 802.11 standards. It should be understood that while the connection between the gateway interface 309 and the set top box interface 104 has been described as a direct connection, the connection can be indirect in the sense that other devices, such as network routers, can be disposed between the gateway interface 309 and the set top box interface 104 on a user's local network.

The decoder/demodulator 304 can be configured to decode/demodulate the signals received in accordance with the coding/modulation scheme applied by the head end and can be configured to store the content in the storage medium 306. Further, the decoder/demodulator 304 can also decode/demodulate content or data signals from the gateway interface 309. The processor 308 can be configured to manage elements of the set top box 300, as discussed in more detail below. The audio/video encoder 310 can be configured to encode and format content in the storage medium 306 for output to a display system 200 via a television interface 312, which can be a High-Definition Multimedia Interface (HDMI) interface. For example, the audio/video encoder 310 can format the content in accordance with an HDMI standard. The user-interface 314 can be a remote control interface while the optional device interface(s) 316 can be an interface for a variety of devices, such as a personal computer, a media player and/or a smart phone. For example, a device interface 316 can be a Universal Serial Bus (USB) interface or can be a wireless interface, such as a wireless interface in accordance with IEEE 802.11 standards. Further, the set top box system 300 can also include optional executable file or applications 318 to aid in utilizing the set top box system 300 as an application client for the gateway 300, as discussed in more detail herein below. For example, applications 318 can perform functions similar to a tru2way application to implement exemplary method embodiments.

It should be noted that the functions of the various elements shown in the figures can be provided through the use of dedicated hardware as well as hardware capable of executing software in association with appropriate software. When provided by a processor, the functions can be provided by a single dedicated processor, by a single shared processor, or by a plurality of individual processors, some of which can be shared. Moreover, explicit use of the term “processor” or “controller” should not be construed to refer exclusively to hardware capable of executing software, and can implicitly include, without limitation, digital signal processor (“DSP”) hardware, read-only memory (“ROM”) for storing software, random access memory (“RAM”), and non-volatile storage. Moreover, all statements herein reciting principles, aspects, and embodiments, as well as specific examples thereof, are intended to encompass both structural and functional equivalents thereof. Additionally, it is intended that such equivalents include both currently known equivalents as well as equivalents developed in the future (i.e., any elements developed that perform the same function, regardless of structure).

Thus, for example, it will be appreciated by those skilled in the art that the block diagrams presented herein represent conceptual views of illustrative system components and/or circuitry embodying the principles of the embodiments. Similarly, it will be appreciated that any flow charts, flow diagrams, state transition diagrams, pseudo-code, and the like represent various processes which can be substantially represented in computer readable media and so executed by a computer or processor, whether or not such computer or processor is explicitly shown.

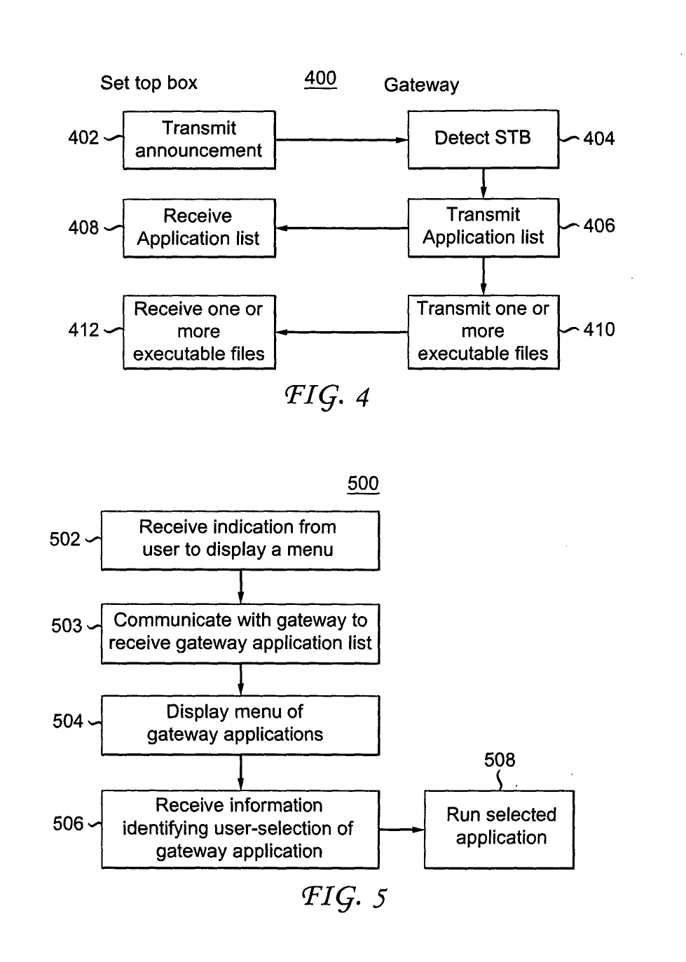

With reference now to FIG. 4 with continuing reference to FIGS. 2 and 3 a method 400 for setting up the set top box system 300 as an application client for the gateway system 100 is illustrated. The method steps that can be performed by the gateway system 100 is provided in the right column of FIG. 4 while the method steps that can be performed by the set top box system 300 are provided in the left column of FIG. 4. It should be noted that the set top box system 300 and the gateway system 100 can be configured to communicate in accordance with a pre-defined communication protocol that can be defined by the service provider. Here, the communication protocol can be configured to permit expansion or modification of interaction capabilities between the set top box system 300 and the gateway system 100. As stated above, the pre-defined communication protocol can be adapted appropriately for particular gateway and set top box devices and applications due to the provision of the devices by a common service provider. Thus, the communication protocol can provide advantages over known systems, as the protocol can be tailored for specific interactions between such devices that permit efficient execution of gateway applications and exchange of information.

The method 400 can begin with a discovery routine. For example, the processor 308 of the set top box 300, at step 402, can transmit an announcement on the local network of the user. The announcement can comprise registration request and can include an identifier allocated by the service provider for the set top box 300. In addition, the processor 308 can transmit the announcement upon connection of the set top box system 300 to the local network and can transmit the announcement periodically thereafter until the set top box is registered with a gateway system 100. After the gateway 100 is connected to the local network, the controller 102 of the gateway system 100, at step 404 can detect that the set top box is connected to the local network of a user. For example, the controller 102 can be configured to monitor any requests it receives to determine whether an announcement in accordance with the pre-defined protocol has been received. Here, after receiving an announcement, the controller 102 can verify the validity of the announcement and, upon verification, can register the set top box system with the gateway 100.

At step 406, the controller 102 of the gateway 100 can transmit an application list to the set top box 300. The application list can include a variety of applications provided by the gateway 100 that can be executed by employing the set top box 300 as an interface with the user. For example, the list can include a yellow pages application, a call log application, a music player application, a Really Simple Syndication (RSS) feed application and a settings application that can be employed to reconfigure the Gateway system 100, as discussed further herein below.

At step 408, the processor 308 of the STB 300 can receive the application list transmitted from the gateway system 100 and can store the application list in the storage medium 306.

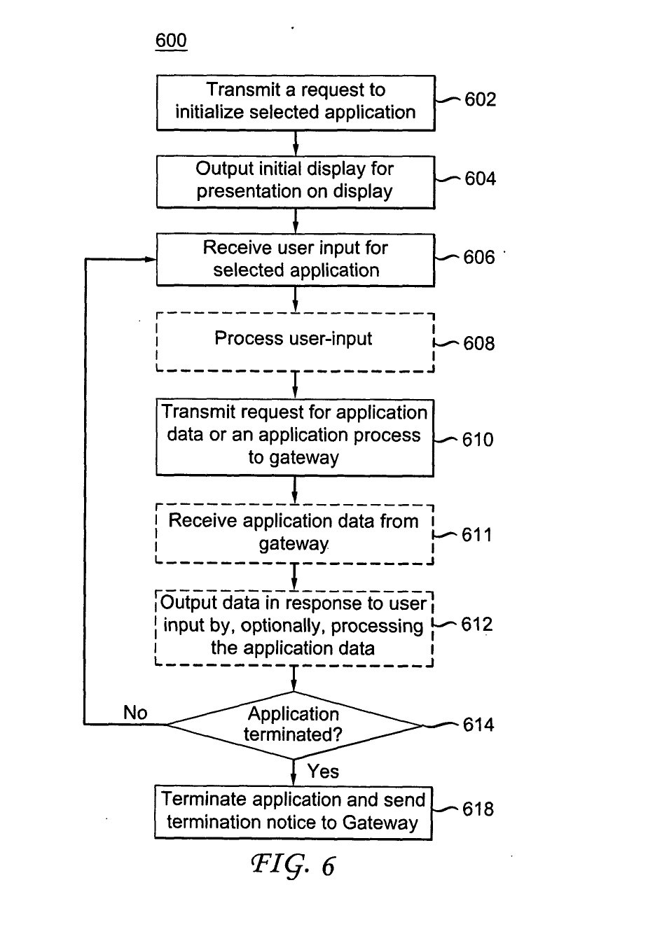

Optionally, at step 410, the controller 102 of the gateway 100 can transmit one or more executable files or applications 318 that can aid the set top box 300 in processing information between a user and the gateway to assist in executing applications at the gateway 100. Here, one executable file or application for each accessible application at the gateway 100 can be provided. Alternatively, a single executable file or application can be employed to run more than one of the accessible applications at the gateway 100. Implementations of the executable files and applications are described in further detail herein below with respect to FIG. 6.

In turn, at optional step 412, the processor 308 of the set top box 300 can receive one or more executable files or applications. For example, the processor 308 can receive the executable files or applications 318 transmitted from the controller 102. Alternatively, the processor 308 can receive executable files or applications 318 from the head end through the receiver 302. Further, in other exemplary embodiments, the one or more executable files or applications 318 can be pre-stored on the storage medium 306 in the set top box 300 prior to its connection to the user's local network.

Referring now to FIG. 5, with continuing reference to FIGS. 2 and 3, a method 500 for employing a set top box as an application client to run gateway applications is illustrated. The method 500 can begin at step 502 in which the processor 308 of the set top box 300 can receive an indication from a user to display a menu. For example, the indication can be received through the user-interface 314 upon user-selection of a dedicated button for an applications menu on a remote control. Alternatively, the user can prompt the display of a general menu using the remote control and can navigate through various menu options to reach an option for a gateway applications menu.

Optionally, at step 503, the processor 308 of the set top box 300 can communicate with the gateway 100 to receive a gateway application list. For example, in response to user-selection of the gateway applications menu at step 502, the processor 308 can transmit a request for the gateway application list to the gateway 100 and the processor 308 can receive the gateway application list from the gateway 100.

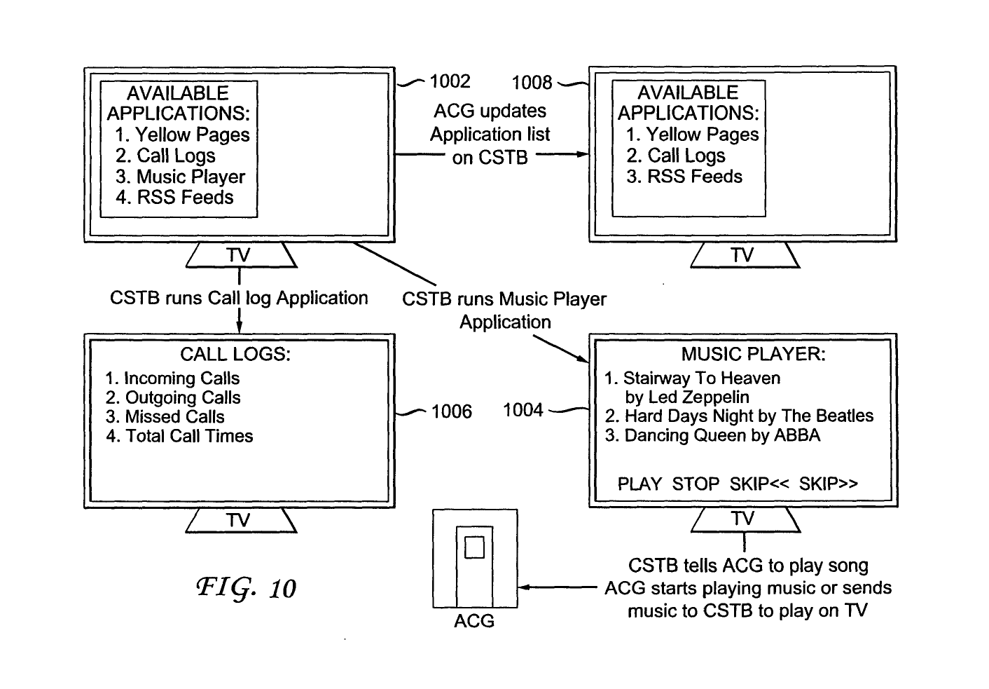

At step 504, the processor 308 of the set top box 300 can direct the display of a menu of accessible gateway applications. For example, the menu can be displayed on the display system 200 using the television interface 312. Further, the menu can comprise a listing of available applications provided by the gateway during the set-up operation described above with respect to method 400, during updates of the listing, described further herein below with respect to methods 800 and 900, or at step 503. FIG. 10 provides several examples of display screens that can be provided during various stages of method 500. Here, the screen 1002 illustrates an example of a display of a menu of accessible gateway applications that can be provided during step 504. As mentioned above and as shown in screen 1002, the available gateway applications can comprise a yellow pages application, a call log application, a music player application and an RSS feed application.

At step 506, the processor 308 of the set top box 300 can receive information identifying a user-selection of an application provided at the gateway system 100. For example, the processor 308 can receive the user-selection through the user-interface 314. Further, the user can employ a remote control to scroll through the menu and select a desired application to run.

At step 508, the processor 308 of the set top box 300 can cooperate with the controller 102 of the gateway 100 to run the selected gateway application.

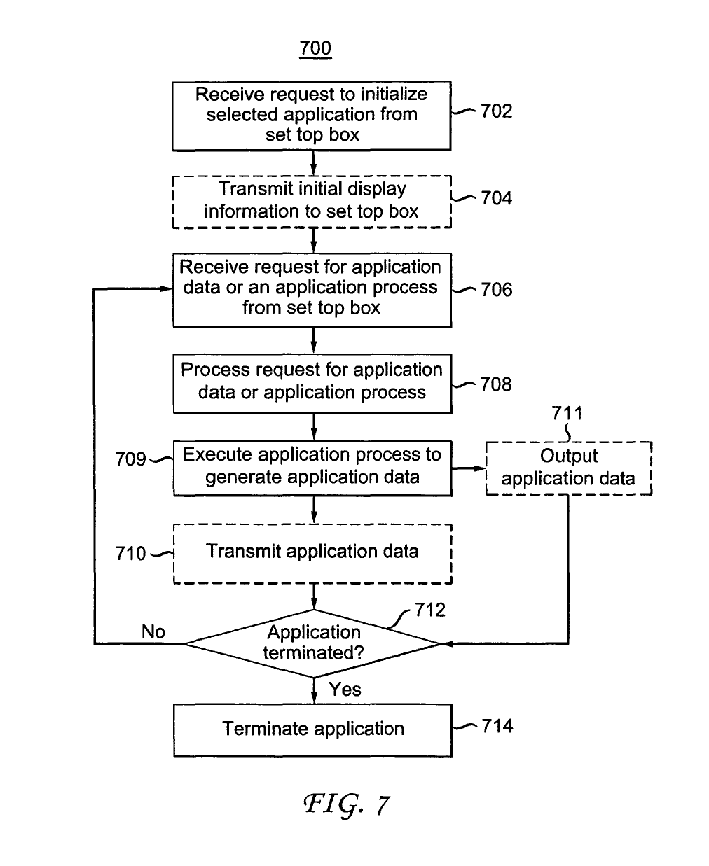

To illustrate one exemplary embodiment of how a selected gateway application can be executed at step 508, reference is made to FIGS. 6 and 7, in which methods 600 and 700 that can be performed by the set top box 300 and the gateway 100, respectively, to implement execution of the selected application are illustrated. It should be understood that methods 600 and 700 can be performed in various ways. For example, methods 600 and 700 can be performed such that processing for the application is performed at the gateway 100 while the set-top box 300 simply drives a display/input combination with the display system 200. Alternatively, the set top box 300 can run an executable file or application 318 to aid in execution of the selected application.

For illustrative purposes, different examples are described in which the user has selected the music player application, the call log application and the gateway settings application. The music player application can be configured to play songs stored in the storage medium 112 of the gateway 100, songs received from or streamed from a wide area network through the cable interface 114 or songs received from or streamed from the user's home network through the device interface 106. For example, the songs can be received from or streamed from the cable head end or can originate from various sites on the internet. Moreover, the call log application can be executed to permit a user to view any calls made or received on one or more VoIP profiles or telephone lines provided through the gateway 100. In addition, the settings application can permit the user to change configuration settings for the gateway system 100.

The method 600 can begin at step 602, in which the processor 308 of the set top box 300 can transmit a request to initialize the selected application to the gateway 100. For example, the request can comprise a simple pre-set, unique code identifying the selected application. The identifier codes can be provided to the set top box with the application list as described above with respect to the method 400.

The method 700 can begin at step 702, in which the controller 102 of the gateway 100 can receive the request to initialize the selected transmitted from the set top box. For example, step 702 can be performed in the display/input combination scenario described above. Here, the controller 102 can receive and process an identifier code to determine which application to execute.

Optionally, at step 704, the controller 102 of the gateway 100 can transmit initial display information for the selected application to the set top box 300. For example, step 704 can be performed in the display/input combination scenario described above. In the music player application example described above, the initial display information can provide a listing of available songs that the music player application can play. Alternatively, for the call log application, the initial display information can include a set of menu options for viewing incoming calls, outgoing calls, missed calls and total call times, among other possible options. In the gateway settings application example, the initial display information can include a status option, which can indicate software and connection configuration status as as well as a password configuration option. The initial display for the gateway settings application example can further include a telephony configuration option, a router configuration option, a wireless configuration option and a multi-media terminal adapter configuration settings option. In certain exemplary implementations, the gateway settings can be password protected. Thus, the initial display information for the gateway settings application can be a user-name and password prompt screen. It should also be noted that, in certain exemplary implementations, the controller 102 can transmit an executable file or application 318 to the set top box for the selected application with the initial display information.

At step 604, the processor 308 of the set top box 300 can output the initial display for presentation on the display system 200. If the gateway 100 has transmitted an executable file or application 318 with the initial display information at step 704, then the processor 308 can store the executable file or application in the storage medium 306 at step 604. As indicated above, the executable file or application can be employed to perform at least a portion of the processing of one or more applications provided at the gateway to improve communication efficiency and to reduce processing latency. For example, rather than receiving the initial display from the gateway application, at step 604, the processor 308 can run a previously stored executable file or application 318 to generate the initial display in response to receiving user-selection of a gateway application in step 506. Alternatively, in the display/input combination scenario, the processor 308 can receive initial display information transmitted from the gateway 100 at step 704 and can compile the information for output to the display system 200. For the music player application example described above, the initial display can comprise a listing of available songs that the music player application can play. Screen 1004 of FIG. 10 illustrates an example of an initial display for a music player application. As provided in screen 1004, in addition to the listing of available songs, the initial display can comprise command options such as play, stop, and skip. Moreover, for the call log application, the initial display can comprise a listing of available call log options, such as incoming calls, outgoing calls, etc., as discussed above. Screen 1006 provides an example of an initial display for a call log application. In the gateway settings application example, as discussed above, the initial display can comprise a user-name and password prompt and/or can include a listing of configuration settings options for software, connections, passwords, telephony, router and other potential configuration settings options.

At step 606, the processor 308 of the set top box 300 can receive user-input for the selected application. The user-input can comprise a user-request for output data or for the execution of a process by the selected application. For example, in the music application example, the processor 308 can receive a user-selection of a song listing in the initial display as a request for output data and can receive user-selection of a command, such as a play command for the selected song, as a request for the execution of a process. Alternatively, in the call log application example, the processor 308 can receive a user-selection of an “incoming calls” option, indicating a user-request for incoming calls information as the output data. Further, for the gateway settings application example, the user-input can comprise a user-name and password, indicating a user-request for a verification process. Here, the executable file or application 318 can be employed to generate a keypad menu to permit the user to select letters and/or numbers for a user-name and password as the input received by the processor 308 at step 604. Alternatively, the user input can comprise a user selection of, for example, a router or telephony configuration settings option, indicating a user-request for other available options for router or telephony configuration settings information as output data. Further, a software configuration menu can be provided and displayed automatically upon user-selection of the configuration settings option. Here, the processor 308 can employ an executable file or application 318 to generate the telephony or router configuration settings menu.

Optionally, at step 608, the processor 308 of the set top box 300 can process the user-input. For example, the processor 308 can process the user-input by employing an executable file or application 318 for the selected application. Here, the user-input can be processed to conform the input to the pre-defined protocol and thereby enable efficient communication between the set top box 300 and the gateway 100. For example, in the music application example provided above, the processor 308 can generate a simple code that can be processed by the controller 102 of the gateway 100 to indicate to the controller that a selected song should be played. Similar codes can be generated for the call log and gateway settings applications to simplify communication between set top box 300 and the gateway 100.

At step 610, the processor 308 of the set top box 300 can transmit a request for application data or an application process to the gateway 100. For example, in the display/combination scenario, the processor 308 can relay the user-input received at step 606. Alternatively, the processor 308 can transmit a request generated with an executable application 318 at step 608. In the music application example, the request can be a request for a user-selected song and a user-selected command, such as a play command. For the call log application example, the request can be a request for information regarding incoming calls, outgoing calls or information related to other options selected by the user. In turn, for the gateway settings example, the request can be a request to verify a submitted user-name and password to permit the user to alter or set the configuration settings for the gateway. Alternatively, the request can be a request to modify the configuration settings for the gateway.

For example, after presentation of the initial display for the gateway settings application, the user can select the telephony or router option, where the indication of the user-selection can be received by the processor 308 of the set top box 300 at step 606. If the user selects the telephony option, the processor 308 can employ the executable file or application 318 to process the selected option and present additional options relating to the telephony settings at step 608. Such options can include a listing of handsets that a user can select to initiate subscription of the handset with the gateway or to initiate removal of the handset from a subscription list. If the user selects the router option, the processor 308 can employ the executable file or application 318 to process the selected option and present additional options relating to the router settings at step 608. Such options can include a listing of an internet protocol (IP) address and subnet mask for the router and a listing of IP addresses and media access control (MAC) for any computing devices connected to the gateway system 100. Here, the user can change the addresses and other router settings by employing a directional and selection buttons on remote control. The user can further employ number keys on the remote control and/or a displayed key pad to change IP addresses and other router settings. Accordingly, the request transmitted by the processor 308 can be a request to change configuration settings, such as subscription of removal of telephone handsets and modification of the IP, subnet or MAC addresses for the router at the gateway 100 or for any computing devices connected to the gateway 100. It should be noted that the router and telephony configuration settings options are used only as examples and any gateway configuration settings that can be modified by a user can be done so through the set top box 300 in accordance with methods 600 and 700.

It should also be noted that the request for application data transmitted by the set top box at step 610 can be a request for output data requested by the user or can be a request for application data used by the set top box to generate the output data requested by the user. Of course, as stated above, the request transmitted at step 610 can also be a request for the execution of an application process.

At step 706, the controller 102 of the gateway 100 can receive the request for the application data or the execution of an application process from the set top box 300 transmitted at step 610.

At step 708, the controller 102 of the gateway 100 can process the received request to determine the application data to transmit to the set top box 100 at step 710 and/or to determine the application process to execute at step 709 to generate application data. For example, in the display/combination scenario, the controller 102 can process the relayed user-input received at step 606. Further, the controller 102 can process the request in accordance with the pre-defined protocol. Thus, in the music player application example, the request can be processed to determine a user-selected song and a user-selected command, such as a play command. In addition, for the call log application example, if the request is for incoming call logs, the request can be processed to determine and retrieve a listing of all recent calls made to one or more profiles or lines serviced by the gateway 100. For both the music player application example and the call log application example, it should be understood that many other types of requests for application data and/or application processes can be made. With regard to the configuration settings application, the request can also be for a variety of different types of application data and/or application processes. For example, if the controller 102 receives a request for a verification of a user-name and password, the controller 102 can process the request to verify the user-name and password. In addition, if the controller 102 receives a request to modify configuration settings, such as subscription of handsets and various router configuration settings, as discussed above, the controller 102 can implement the requested application process. For example, the controller 102 can subscribe a selected handset to the gateway 100 or can remove a selected handset from a subscription list. Further, the controller 102 can modify the IP, subnet or MAC addresses for the router at the gateway 100 or for any computing devices connected to the gateway 100 in accordance with the request.

Optionally, at step 710, the controller 102 of the gateway 100 can transmit application data to the set top box 100. For example, in the display/input combination scenario, the controller 102 can stream audio data for the selected song in the music application example. Alternatively, the controller 102 can transmit the entire audio file for the selected song. With regard to the call log application, the controller 102 can transmit the requested call logs. For example, if the request received from the set top box 300 at step 706 is a request for an incoming calls log, an outgoing calls log, a missed calls log or a total call times log, the controller 102 can transmit a listing of incoming calls, outgoing calls, missed calls log or total call times, respectively, for any one or more profiles/lines serviced or provided by the gateway 100. In addition, for the configuration settings application example, the application data transmitted to the set top box 100 can include any data requested in the request received at step 706, such as a request for a software version status. In addition, if the request received at step 706 was a request for an application process, for any of the application examples, then the application data transmitted to the set top box 300 by the controller 102 at step 710 can include an indication that the process has been completed. For example, in the configuration settings application example, the application data can indicate that a selected handset has been subscribed with to the gateway 100 or has been removed from a subscription list. Additionally, the application data can indicate that an IP, subnet or MAC addresses has been modified in accordance with the request received at step 704.

At optional steps 611 and 612, the processor 308 of the set top box 300 can receive the application data transmitted from the gateway 100 at step 710 and can output data for presentation on the display system 200, respectively. Optionally, the processor 308 of the set top box 300 can process the received application data to generate the output data for presentation on the display system. For example, in the display/input combination scenario for the music application example, the processor 308 can receive streaming audio data for the selected song and can process the streaming data using the decoder/demodulator 304 and the A/V encoder 310 for output of the audio data to the display system 200. Alternatively, the processor 308 can run an executable file or application 318 to play an audio file received from the gateway 100 at step 710 for output of audio data on the display system 200. For the call log application example, the processor 308 can output appropriate call log listing data transmitted from the gateway 100 at step 710 for presentation on the display system 200. It should also be noted that the application data received from the gateway 100 can be output directly to the display device. For example, with regard to the configuration settings application example, the processor 308 can output an indication that a user-name and password has been verified or can output an indication that configuration settings have been changed. For example, the data output to the display device can modify a display listing a set of handsets subscribed to the gateway 100 to indicate that a selected handset has been successfully subscribed or unsubscribed in accordance with user-input received at step 606. Further, the data output to the display device can modify a display listing the IP, subnet or MAC addresses for the router at the gateway 100 or for any computing devices connected to the gateway 100 to indicate that any one or more of such addresses have been successfully changed in accordance with user-input received at step 606.

It should be understood that the output data can result from the execution of an application process in a variety of ways. For example, the output data can correspond to audio data presented on the display device 200 resulting from execution of the process performed by the executable file or application 318 on the audio data received from the gateway 100. Alternatively, the output data can correspond to an indication that router addresses have been modified, where the indication results from executing the configuration settings application to institute the address change.

It should also be noted that steps 611, 612 and 710 need not be performed in certain scenarios. For example, a request transmitted from the set top box at step 610, and/or received by the set top box from the user at step 606, can be a request for the gateway to perform an action. For example, in the music application example, the request can be a request for the gateway to play music through other output interfaces. In this scenario, steps 611, 612 and 710 need not be performed, as the output data can be presented elsewhere by the gateway.

Thus, referring again to the method 700, after executing an application process to generate application data at step 709, the method 700 can proceed to optional step 711, in which the controller 102 of the gateway system 100 can output the application data. For example, in the music application example, where the request is for the gateway to play music through other output interfaces, the application data can correspond to the selected music and can be output through a handset connected to the user interface 110 or a device connected to the device interface 106. For example, the device can be a stereo system with speakers through which the selected music can be played.

At step 614, the processor 308 of the set top box 300 can determine whether the selected application should be terminated. For example, the processor 308 can determine that the application should be terminated if the set top box 300 is powered down or if the user provides or selects an option to exit from the selected application. If the application should not be terminated, then the method 600 can proceed to step 606 and can be repeated. For example, in the music player application example, the processor 308 can receive a selection of a different song or can receive a different command for a currently played song, such as a “stop” command. Further, in the call log application example, the processor 308 can receive a selection for a different call log, such as an outgoing call log for any one or more profiles/lines serviced or provided by the gateway 100. For the configuration settings example, the processor 308 can receive a selection for a different configuration settings option, such as an option to display status information of software running on the gateway 100 or connections to the gateway 100. Thereafter, the method can repeat as discussed above to permit the set top box 300 and the application at the gateway 100 to process the newly selected option.

If the application should be terminated, the method 600 can proceed to step 618, in which the processor 308 of the set top box terminates the application and transmits a notice of termination of the selected application to the gateway 100.

Returning to method 700, the controller 102 of the gateway 100 can, at step 712, determine whether the selected application should be terminated. For example, the controller 102 can base the determination on whether a termination notice has been received from the set top box 100. If a termination notice has not been received and the controller 102 determines that the application should not be terminated, then the method 700 can proceed to step 706 and can be repeated. For example, in the music player application example, the controller 102 can receive a request for a different song or receive a request corresponding to a different command for a currently played song, such as a “stop” command. Similarly, the controller 102 can receive different requests for the other application examples. Thereafter, the method can repeat as discussed above to permit the corresponding application at the gateway to process the newly selected option.

Otherwise, if the application should be terminated, the method 700 can proceed to step 714, in which the controller 102 of the gateway can terminate the application. As stated above, the termination can be performed in response to receiving a termination notice from the set top box 300.

It should be understood that although methods 500-700, and also methods 800 and 900 below, have been described with respect to receiving information or indications from a user through the user-interface 314, the information or indications can alternatively be received through the television interface 312, wherein the user provides such information or indications directly to the user's television or display system 200. For example, the user can provide a request for the gateway system 100 to play music to its television set, which in turn, can transmit the request to the set top box for receipt at step 606.

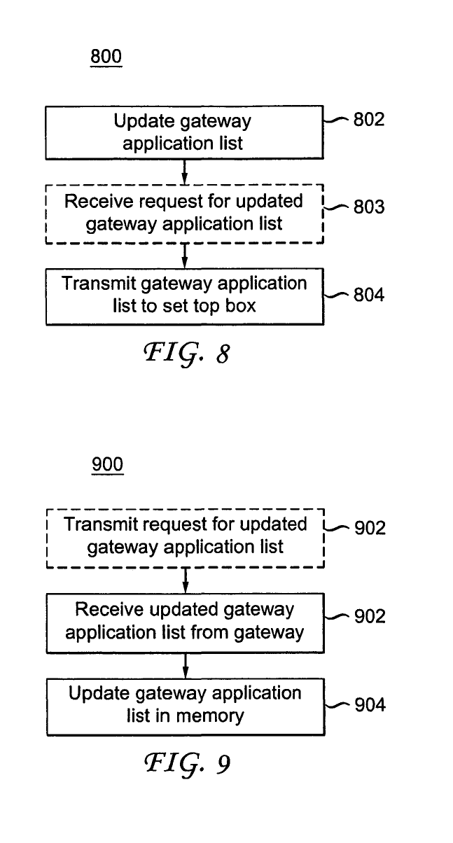

Referring now to FIGS. 8 and 9 with continuing reference to FIGS. 2-3 and 6-7, methods 800 and 900 for updating a gateway application list at a set top box that can be performed by the gateway 100 and the set top box 300, respectively, are illustrated. The method 800 can begin at step 802 in which the controller 102 of the gateway 100 can update the gateway application list. Here, the gateway application list can be updated in a variety of ways. For example, the application list can be updated remotely by a cable head end. Alternatively, the application list can be updated manually by a user. For example, the user can add applications from the cable head end or from the internet using the user-interface 110 or using a computing device connected to the gateway 100 through the device interface 106. Alternatively, the application list can be updated using the configuration settings application described above. For example, the processor 308 of the set top box 300 can receive a user-input requesting a listing of available applications that can be downloaded from the head end or from the internet. In turn, the methods 600 and 700 can be performed to output application data on the display device 200. Here, the processor 308 can receive a user-selection of the application to be downloaded at step 606 and the methods 600 and 700 can be performed to initiate the downloading of the selected application to the gateway 100. Conversely, any one or more applications can be removed from the application list through the configuration settings application in accordance with methods 600 and 700, as discussed above.

Optionally, at step 803, the controller 102 of the gateway system 100 can receive a request for an updated gateway application list from the set top box 300. For example, the request can be received after a user triggers an update of the application list, as discussed above with respect to step 802. Alternatively, the request can be one of a series of requests transmitted periodically by the set top box 300 to ensure that the set top box retains an accurate listing of applications available at the gateway 100.

At step 804, the controller 102 can transmit the updated application list to the set top box 300. For example, an updated application list can be transmitted to the set top box each time the application list is updated or in response to each request received at optional step 803.

Optionally, at step 901, the processor 308 of the set top box 300 can transmit a request for an updated gateway application list from the set top box 300. For example, the request can be transmitted after a user triggers an update of the application list, as discussed above with respect to step 802. Alternatively, the request can be one of a series of requests transmitted periodically by the set top box 300 to ensure that the set top box retains an accurate listing of applications available at the gateway 100.

At step 902, the processor 308 of the set top box 300 can receive a gateway application list transmitted from the gateway 100 at step 804.

At step 904, the processor 308 of the set top box 300 can update the gateway application list in its memory. For example, the processor 308 can replace any existing gateway application list in the storage medium 306 with the gateway application list received at step 902. Screens 1002 to 1008 of FIG. 10 illustrate exemplary displays for updating a gateway application list stored at a set top box that can be generated by the processor 308.

It should be understood that although only a few examples of applications have been provided, many other types of gateway applications can be executed through the set top box as discussed herein. For example, such gateway applications can include Facebook applications, Twitter applications, or eCommerce applications, such as Amazon applications, etc. In addition, any applications modified for implementation by smartphones can also be modified to be implemented by a gateway system. Further, displays can be scaled by the gateway device and/or by executable files 318 at the set top box for output to the display system 200. Alternatively, the gateway system 100 can store versions of the gateway applications for use with the display system 200 so that output data can be properly displayed. For example, to permit the proper display of output data on a display system 200, the versions of the applications can be slightly different from corresponding applications executed by the gateway system 100 alone.

Having described preferred embodiments for systems and methods (which are intended to be illustrative and not limiting), it is noted that modifications and variations can be made by persons skilled in the art in light of the above teachings. It is therefore to be understood that changes can be made in the particular embodiments disclosed which are within the scope as outlined by the appended claims. While the forgoing is directed to various embodiments, other and further embodiments can be devised without departing from the basic scope thereof.

1. A method, comprising:
receiving, at a set top box, information identifying a user-selection of an application provided at a gateway system;
transmitting from the set top box to the gateway system a request to initialize the selected application; and
directing, at the set top box, the presentation of output data resulting from execution of a process by the selected application.

2. The method of claim 1, further comprising:
receiving, at the set top box, a user-request for the output data or for the execution of the process by the selected application.

3. The method of claim 2, further comprising:
receiving application data from the gateway system; and
processing the application data at the set top box to generate the output data.

4. The method of claim 2, further comprising:
relaying the user-request to the gateway system; and
receiving the output data from the gateway system.

5. The method of claim 2, wherein the user-request is a request to modify configuration settings of the gateway system and wherein the output data indicates a successful modification of the configuration settings.

6. The method of claim 1, further comprising:
transmitting an announcement to the gateway system identifying the set top box; and
receiving an application list indicating applications that are available at the gateway system.

7. The method of claim 6, further comprising:
receiving an updated application list from the gateway; and
updating the application list in local storage at the set top box.

8. A method, comprising:
receiving, at a gateway system and from a set top box, a request for the execution of a process by an application provided at the gateway system or for application data resulting from execution of the process by the application;
executing the process at the gateway to generate the application data; and
transmitting the application data.

9. The method of claim 8, wherein the request is a request to modify configuration settings of the gateway system and wherein the application data indicates a successful modification of the configuration settings.

10. The method of claim 8, wherein the application is a music player application and wherein the application data is an entire music file or streaming data of the music file.

11. The method of claim 8, wherein the application is a call log application and wherein the application data includes call log information.

12. The method of claim 8, wherein the transmitting includes transmitting the application data to the set top box.

13. The method of claim 8, wherein the transmitting includes transmitting the application data for output at the gateway.

14. A system comprising:
a set top box configured to direct a presentation of a list of applications available at a gateway system to a user and to enable the user to interact with the gateway system through the set top box to permit execution of a selected application.

15. The system of claim 14, wherein the set top box further includes an executable file or application configured to perform a portion of the execution of the selected application.

16. The system of claim 14, wherein the set top box is further configured to receive a request from the user for the execution of a process by the selected application or for output data resulting from execution of the process by the application.

17. The system of claim 16, wherein the set top box is further configured to transmit the request to the gateway system.

18. The system of claim 17, wherein the gateway system is further configured to process the request to generate application data for transmission to the set top box or for output at the gateway system.

19. The system of claim 18, wherein the application data is the output data.

20. The system of claim 18, wherein the set top box is further configured to process the application data to generate the output data.
